(19) United States
(12) Patent Application Publication
(10) Pub. No.: US 2025/0284726 A1
(43) Pub. Date: Sep. 11, 2025

(54) Systems and Methods for Identifying and Diagnosing Unexpected, Irregular, Out of Bounds, and/or Outlier Behavior Within Computing Devices and Networks

(71) Applicant: Activision Publishing, Inc., Santa Monica, CA (US)

(72) Inventors: Steven Moss, Kenmore, WA (US); Jeffrey Luer, Los Angeles, CA (US)

(21) Appl. No.: 19/064,564

(22) Filed: Feb. 26, 2025

Related U.S. Application Data
(60) Provisional application No. 63/562,506, filed on Mar. 7, 2024.

(51) Int. Cl. G06F 16/35; G06F 9/451; G06F 40/284; G06N 3/094

(52) U.S. Cl. CPC G06F 16/35; G06F 9/451; G06F 40/284; G06N 3/094

(57) ABSTRACT

Systems and methods of identifying one or more outliers in unstructured data include enabling, using a computing device, a user to generate a query to identify one or more outliers in the unstructured data, receiving, by a tokenizer, the unstructured data in response to the user's query, generating, by the tokenizer, token IDs corresponding to a plurality of tokens representative of the unstructured data, processing, by a first machine learning model, the token IDs into first latent space representations, correlating, by the first machine learning model, the first latent space representations with context data, processing, by a semantic outlier(s) module, the first latent space representations to identify one or more outliers, and processing, by a classifier model, the identified one or more outliers in order to identify one or more character sequences indicative of inconsistent portions of the unstructured data.

### CROSS-REFERENCE

The present application relies on, for priority, United States Patent Provisional Application No. 63/562,506, titled “Systems and Methods for Identifying and Diagnosing Unexpected, Irregular, Out of Bounds and/or Outlier Behavior Within Computing Devices and Networks” and filed on Mar. 7, 2024, which is herein incorporated by reference in its entirety.

### FIELD

The present specification is related generally to the field of identifying inconsistent behavior in the context of computing devices and networks. More specifically, the present specification is related to systems and methods for using machine learning models to detect, diagnose, and interpret data of interest.

### BACKGROUND

Networked computing environments are becoming increasingly complex and therefore difficult to maintain due to a vast variety of interconnected computing resources such as, for example, general purpose computing systems, smart phones, tablet computers, wearables, and IOT appliances and devices such as smart lights, set-top boxes and IP cameras that have network adapters to allow the devices to connect over one or more private or public networks. This increasing universe of interconnected devices has also enabled an increase in computer-controlled sensors that are likewise interconnected and configured to collect new and large sets of data.

Standalone as well as networked computing devices or hosts may regularly perform various tasks that need to be monitored through software agents, the interception of network traffic and other approaches to collect data. A network administrator may collect and analyze data corresponding to tasks performed by computing devices in order to ensure smooth operation with minimum downtime that warrants timely detection of anomalistic events such as device misconfigurations, performance degradation, malicious access to network resources and/or malware attacks.

Accordingly, there is need for improved techniques aimed to detect abnormal behavior in computing devices. There is also need to diagnose the identified unexpected, out of bounds, abnormal, and/or anomalous behavior (collectively referred to as data of interest) by providing context or information as well as an interpretation or explanation related to the inconsistent behavior.

### SUMMARY

The following embodiments and aspects thereof are described and illustrated in conjunction with systems, tools and methods, which are meant to be exemplary and illustrative, and not limiting in scope. The present application discloses numerous embodiments.

The present specification discloses a computer implemented method of identifying one or more anomalies within a first set of data, comprising: using a computing device, generating a graphical user interface configured to receive a request to identify one or more anomalies in the first set of data; receiving the first set of data in response to the user's query; generating a plurality of tokens representative of the first set of data; using a tokenizer, generating token ID sequences corresponding to the plurality of tokens; using a first machine learning model, processing the token ID sequences into first latent space representations; using the first machine learning model, associating each of the plurality of tokens with one or more portions of context data by correlating the first latent space representations with the one or more portions of context data; and processing the first latent space representations to identify the one or more anomalies, wherein the one or more anomalies is correlated with the one or more portions of context data.

Optionally, the first set of data comprises data related to security assessments of a plurality of networked hosts. Optionally, the one or more portions of context data comprises data indicative of environments, events, topics or themes associated with at least a subset of the data related to said security assessments. Optionally, the one or more portions of context data comprises at least one of host names, host configurations, identity and access management policies, user names, user permissions, and insecure code lines.

Optionally, the first set of data is unstructured text data.

Optionally, the computer-implemented method further comprises generating the plurality of tokens by determining a plurality of possible segmentations of the first set of data, calculating a probability of each of the segmentations and selecting one or more segmentations with highest probabilities.

Optionally, the computer-implemented method further comprises generating the correlation by training the first machine learning model to minimize cosine distance between the first latent space representations and one or more second latent space representations of context data. Optionally, the computer-implemented method further comprises generating the correlation by maximizing orthogonality of the first latent space representations and unrelated context data.

Optionally, the first machine learning model is a at least one of a recurrent neural network or convolutional neural network and the computer-implemented method further comprises applying a contrastive learning algorithm to neuron activations of one or more hidden layers of the first machine learning model.

Optionally, the computer-implemented method further comprises, using the tokenizer, applying a unigram language model.

Optionally, the computer-implemented method further comprises identifying one or more character sequences indicative of inconsistent portions of the first set of data using a classifier model and applying an integrated gradients algorithm to neuron activations of one or more hidden layers of the classifier model.

The specification also discloses a computer implemented method of identifying one or more outliers in unstructured data related to security assessments of a plurality of networked hosts, comprising: receiving a request to identify one or more outliers in the unstructured data; receiving the unstructured data in response to the request; generating a plurality of tokens representative of the unstructured data and token ID sequences corresponding to the plurality of tokens using a tokenizer; processing the token ID sequences into first latent space representations using a first machine learning model; using the first machine learning model, correlating the first latent space representations with context data in order to associate each of the plurality of tokens with most likely context data, wherein the context data comprises at least one of host names, host configurations, identity and access management policies, user names, user permissions, and insecure code lines; processing the first latent space representations to identify the one or more outliers, wherein each of the one or more outliers is correlated with context data; and processing, by a classifier model, the identified one or more outliers in order to identify one or more character sequences indicative of inconsistent portions of the unstructured data.

Optionally, the unstructured data is text data.

Optionally, the computer-implemented method further comprises generating the plurality of tokens by determining a plurality of possible segmentations of the unstructured data, calculating a probability of each of the segmentations and selecting one or more segmentations with highest probabilities.

Optionally, the computer-implemented method further comprises generating the correlation by training the first machine learning model to minimize cosine distance between the first latent space representations and one or more second latent space representations of context data. Optionally, the computer-implemented method further comprises maximizing orthogonality of the first latent space representations and unrelated context data.

Optionally, the first machine learning model is at least one of a recurrent neural network or convolutional neural network and the computer-implemented method further comprises applying a contrastive learning algorithm to neuron activations of one or more hidden layers of the first machine learning model.

Optionally, the computer-implemented method further comprises, using the tokenizer, applying a unigram language model.

Optionally, the computer-implemented method further comprises identifying one or more character sequences indicative of inconsistent portions of the unstructured data using a classifier model.

Optionally, the computer-implemented method further comprises applying an integrated gradients algorithm to neuron activations of one or more hidden layers of the classifier model.

In some embodiments, the present specification also discloses a computer implemented method of identifying data of interest within target data related to security assessment of a plurality of networked hosts, comprising: enabling, using a computing device, a user to generate a query to identify one or more anomalies in the target data, wherein the computing device stores the target data and context data; receiving the target data in response to the user's query; generating, by a tokenizer, token ID sequences corresponding to a plurality of tokens representative of the target data; processing, by a first machine learning model, the token ID sequences of the plurality of tokens into first latent space representations; correlating, by the first machine learning model, the first latent space representations with context data in order to associate each of the plurality of tokens with most likely context data; and processing, by a module, the first latent space representations to identify data of interest, wherein the data of interest is correlated with context data.

Optionally, the target data is unstructured text data.

Optionally, the plurality of tokens is generated by determining all possible segmentations of the target data, calculating a probability of each segmentation and selecting a segmentation with the highest probability.

Optionally, the correlation is generated by training the first machine learning model to minimize cosine distance between the first latent space representations and second latent space representations of context data and maximize orthogonality of the first latent space representations and random unrelated context data.

Optionally, the first machine learning model is a convolutional neural network.

Optionally, a contrastive learning algorithm is applied to neuron activations of one or more hidden layers of the first machine learning model.

Optionally, the module is configured to implement a local outlier factor algorithm.

Optionally, the tokenizer is configured to implement a unigram language model.

Optionally, the method further comprises processing, by a classifier model, the identified data of interest in order to identify one or more character sequences indicative of inconsistent portions of the target data.

Optionally, an integrated gradients algorithm is applied to neuron activations of one or more hidden layers of the classifier model.

In some embodiments, the present specification also discloses a computer implemented method of identifying one or more outliers in unstructured data related to security assessment of a plurality of networked hosts, comprising: enabling, using a computing device, a user to generate a query to identify one or more outliers in the unstructured data, wherein the computing device stores the unstructured data and context data; receiving the unstructured data in response to the user's query; generating, by a tokenizer, token ID sequences corresponding to a plurality of tokens representative of the unstructured data; processing, by a first machine learning model, the token ID sequences into first latent space representations; correlating, by the first machine learning model, the first latent space representations with context data in order to associate each of the plurality of tokens with most likely context data; processing, by a module, the first latent space representations to identify one or more outliers, wherein each of the one or more outliers is correlated with context data; and processing, by a classifier model, the identified one or more outliers in order to identify one or more character sequences indicative of inconsistent portions of the unstructured data.

Optionally, the unstructured data is text data.

Optionally, the plurality of tokens is generated by determining all possible segmentations of the unstructured data, calculating a probability of each segmentation and selecting a segmentation with the highest probability.

Optionally, the correlation is generated by training the first machine learning model to minimize cosine distance between the first latent space representations and second latent space representations of context data and maximize orthogonality of the first latent space representations and random unrelated context data.

Optionally, the first machine learning model is a convolutional neural network.

Optionally, a contrastive learning algorithm is applied to neuron activations of one or more hidden layers of the convolutional neural network.

Optionally, the first machine learning model is a recurrent neural network.

Optionally, the model implements a local outlier factor algorithm.

Optionally, the tokenizer implements a unigram language model.

Optionally, an integrated gradients algorithm is applied to neuron activations of one or more hidden layers of the classifier model.

In some embodiments, the present specification also discloses a computer implemented method of identifying one or more outliers in unstructured text data related to security assessment of a plurality of networked hosts, comprising: enabling, using a computing device, a user to generate a query to identify one or more outliers in the unstructured data, wherein the computing device stores the unstructured data and context data; receiving, by a tokenizer, the unstructured data in response to the user's query; generating, by the tokenizer, token IDs corresponding to a plurality of tokens representative of the unstructured text data, wherein the tokenizer implements a unigram language model; processing, by a first machine learning model, the token IDs corresponding to the plurality of tokens into first latent space representations, wherein a contrastive learning algorithm is applied to neuron activations of one or more hidden layers of the first machine learning model; correlating, by the first machine learning model, the first latent space representations with context data in order to associate each of the plurality of tokens with most likely context data; processing, using a local outlier factor algorithm, the first latent space representations to identify one or more outliers, wherein each of the one or more outliers is correlated with context data; and processing, by a classifier model, the identified one or more outliers in order to identify one or more character sequences indicative of inconsistent portions of the unstructured data.

Optionally, an integrated gradients algorithm is applied to neuron activations of one or more hidden layers of the classifier model.

Optionally, the first machine learning model is a convolutional neural network.

The aforementioned and other embodiments of the present specification shall be described in greater depth in the drawings and detailed description provided below.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1A is a block diagram illustration of a data of interest detection and diagnosis system, engine or pipeline, in accordance with some embodiments of the present specification;

FIG. 1B is an illustration of an information technology infrastructure system or environment in which the data of interest detection and diagnosis system, engine or pipeline is implemented, in accordance with some embodiments of the present specification;

FIG. 2 shows a point density graph illustrating benign data points and inconsistent data or data of interest, in accordance with some embodiments of the present specification;

FIG. 3 is a flowchart of a plurality of steps of a method of detecting and diagnosing anomalies or outliers in unstructured text data and correlating the unstructured text data with most likely context data, in accordance with some embodiments of the present specification;

FIG. 4 shows exemplary data for interpreting outputs of the data of interest detection and diagnosis system, in accordance with some embodiments of the present specification;

FIG. 5A shows a first exemplary output identifying data of interest, in accordance with some embodiments of the present specification; and

FIG. 5B shows a second exemplary output identifying another data of interest, in accordance with some embodiments of the present specification.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In various embodiments, a computing device includes an input/output controller, at least one communications interface and system memory. The system memory includes at least one random access memory (RAM) and at least one read-only memory (ROM). These elements are in communication with a central processing unit (CPU) to enable operation of the computing device. In various embodiments, the computing device may be a conventional standalone computer or alternatively, the functions of the computing device may be distributed across multiple computer systems and architectures.

In some embodiments, execution of a plurality of sequences of programmatic instructions or code enable or cause the CPU of the computing device to perform various functions and processes. In alternate embodiments, hard-wired circuitry may be used in place of, or in combination with, software instructions for implementation of the processes of systems and methods described in this application. Thus, the systems and methods described are not limited to any specific combination of hardware and software.

The term “module” or “engine” used in this disclosure may refer to computer logic utilized to provide a desired functionality, service or operation by programming or controlling a general purpose processor. Stated differently, in some embodiments, a module, application or engine implements a plurality of instructions of programmatic code to cause a general purpose processor to perform one or more functions. In various embodiments, a module, application or engine can be implemented in hardware, firmware, software or any combination thereof. The module, application or engine may be interchangeably used with unit, logic, logical block, component, or circuit, for example. The module, application or engine may be the minimum unit, or part thereof, which performs one or more particular functions.

The term “data of interest” or “DOI” as used in this disclosure and throughout the specification may refer to anomalies, unexpected data, out of bounds events, outlier data, deviant data, abnormal data, inconsistent data, behavior and/or changes in state, and/or data indicative of a materially significant change in state occurring within computing devices and networks.

The term “host” used in this disclosure may refer to any computer connected to a network. It can provide information, applications or services to other hosts or nodes on the network. Some examples include, but are not limited to, computers, personal electronic devices, thin clients, and multi-functional devices. On a TCP/IP network, each host has a number that, together with a network identity, forms its own unique IP address. It should further be appreciated that, in one embodiment, the servers or host computers disclosed herein are configured to interact or communicate with at least 50 remotely located devices concurrently.

The term “CVE” used in this disclosure may refer to Common Vulnerabilities and Exposures which is a glossary that classifies vulnerabilities. The glossary analyzes vulnerabilities and then uses the Common Vulnerability Scoring System (CVSS) to evaluate the threat level of a vulnerability. Stated differently, CVE is a publicly listed catalog of known security threats. The catalog is sponsored by the United States Department of Homeland Security (DHS), and threats are divided into two categories: vulnerabilities and exposures.

The term “contrastive learning” used in this disclosure may refer to a deep learning technique for unsupervised representation learning. The goal is to learn a representation of data such that similar instances are close together in the representation space, while dissimilar instances are far apart.

The term “latent space representation” used in this disclosure may refer to a lower-dimensional space where the essential features of the original high-dimensional data are preserved. Thus, a latent space is an abstract multi-dimensional space that encodes a meaningful internal representation of externally observed events or data. Samples that are similar in the external world are positioned close to each other in the latent space.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

### Overview

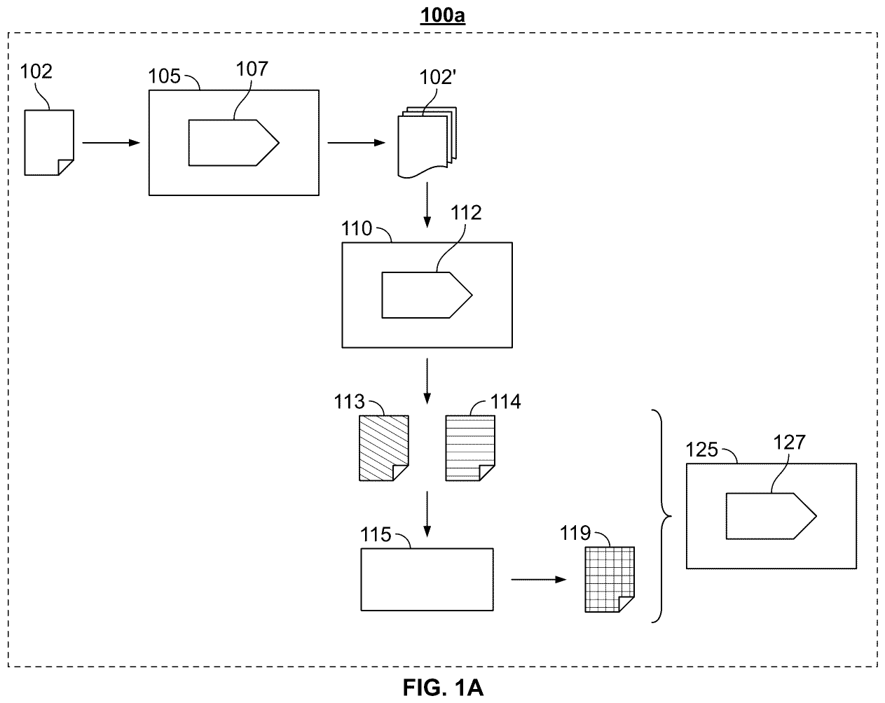

FIG. 1A is a block diagram illustration of a data of interest detection and diagnosis system or pipeline 100a, in accordance with some embodiments of the present specification. The system 100a includes a tokenization module 105 that implements a unigram tokenizer 107, a vectorization module 110 that implements a first ML model 112, a semantic outlier(s) detection (SOD) module 115 that implements a LOF (local outlier factor) algorithm and an interpretation module 125 that implements a classifier model 127.

FIG. 1B is an illustration of an information technology infrastructure system or environment 100b in which the data of interest detection and diagnosis system, engine or pipeline 100a is implemented, in accordance with some embodiments of the present specification. In embodiments, the environment 100b includes one or more hosts or computing devices 101 (with associated storage resources 101′) such as, for example, servers, personal computers and/or IOT (Internet of Things) smart devices that are in data communication with each other over a network 120. In some embodiments, at least a subset of the hosts or computing devices 101 may be implemented by a cloud 121 of computing platforms. In various embodiments, the network 120 is wired and/or wireless and may include private Intranet and/or public Internet.

At least one client computing device 122 is in data communication with the network 120 and has an associated database system 123. In some embodiments, the client computing device 122 implements the data of interest detection and diagnosis system, engine or pipeline 100a which may receive user queries to access and process at least a subset of security assessment data stored in the database 123 in order to determine and diagnose anomalies. The security assessment data is acquired and stored in the database 123 as a result of scanning various hosts or computing devices 101 from time to time.

In some embodiments, security assessment data refers to information technology infrastructure related unstructured text data such as, but not limited to, hostnames, library names, data indicative of CVEs (Common Vulnerabilities and Exposures), as well as other network and host data such as, but not limited to, configuration data, traffic statistics, packet headers, service requests, operating system calls, running computing processes, inter-process communication (that is, the mechanisms provided by an operating system for processes to manage shared data), application logs and/or file-system changes. In some embodiments, the security assessment data have been acquired for security assessment over a historical or past period of time, such as over the last few days, weeks, or months (referred to as historical security assessment data). In some embodiments, the security assessment data is current, i.e. security assessment data that have been acquired most recently, such as within the day, hour, or minute (referred to as current security assessment data or target security assessment data 102).

In some embodiments, at least a subset of the historical security assessment data is used as a training dataset and is referred to as training security assessment data.

In some embodiments, the database 123 also stores context data that is indicative of environments, events, topics or themes associated with at least a subset of the security assessment data. For example, the security assessment data corresponding to CVEs may have associated context data such as, but not limited to, CVE names, and CVSS (Common Vulnerability Scoring System) scores. Additional context data may include, for example, device identifiers, operating system identifiers, host names and configurations or insecure cloud IAM (Identity and Access Management) policies, user names and permissions, and insecure code lines. In some embodiments, at least a subset of the context data is used as a training dataset and is referred to as training context data.

### Tokenization Module 105

As known to persons of ordinary skill in the art, tokenization refers to an algorithmic procedure directed towards dividing a phrase, sentence, paragraph, or one or more text documents into smaller components known as tokens. These tokens could be a word, a subword, or simply a single character. Referring now to FIG. 1A, in accordance with some aspects, the module 105 includes a plurality of instructions of programmatic code which when executed implement the unigram tokenizer 107 that leverages a statistical unigram language model to estimate the likelihood of different words and determine an optimal vocabulary size for tokenization. Upon receiving target security assessment data 102 as input, the unigram tokenizer 107 performs an iterative process of estimating token probabilities, calculating loss, and reducing vocabulary size in order to generate meaningful words, subwords or tokens 102′.

As a non-limiting example, target security assessment data 102 may be as follows:
[foo::10.1.23.45, k8s-123456789-c-20240222-12345-e9ac62a0-d8bq′]

The unigram tokenizer 107 would identify the following subwords or tokens 102′:
[[‘_’, foo, ‘::10.1.23.4, ‘5’], [‘_’, k8s, ‘-123456789-’, ‘c’, ‘-20240222-12345-’, ‘e’, ‘9’, ‘ac’, ‘62’, ‘a’, ‘0’, ‘-’, ‘d’, ‘8’, ‘bq’]]

Finally, token IDs are automatically assigned to each of the words, subwords or tokens 102′, as follows (these token IDs are provided as input to the first ML model 112):
[[11, 12, 2918, 54], [11, 32, 10, 104, 24, 1123, 45, 51, 239, 345, 25, 61, 10, 42, 48, 1613]]

For tokenization, the unigram tokenizer 107 assigns probabilities to sequences of tokens with an assumption that the occurrence of each word is independent of its previous word which enables calculating the probability of the target security assessment data 102 as the product of the probabilities of its constituent tokens. Thus, to tokenize, the unigram tokenizer 107 is configured to determine all possible segmentations of the target security assessment data 102 and calculate the probability of each segmentation. The segmentation with the highest probability is selected as the tokenization of the data 102. This ensures that words are divided into meaningful subword units according to their likelihood of occurrence.

Training of the unigram tokenizer 107 involves starting with a large vocabulary and iteratively removing tokens until a desired size is achieved. At each iteration, a loss is calculated on a training corpus. Effective reduction of the vocabulary is determined by analyzing the loss. Tokens that have the least impact on increasing the loss are selected for removal. In some embodiments, loss on the training corpus is computed by tokenizing all words in the corpus and summing the frequency of occurrence of each word multiplied by the opposite logarithm of the probability associated with its tokenization.

### Vectorization Module 110

In accordance with aspects of the present specification, the vectorization module 110 is configured to generate latent space representations of the words, subwords or tokens 102′ and associate context data with the words, subwords or tokens 102′. In some embodiments, the vectorization module 110 leverages the contrastive learning algorithm to generate latent space representations of the words, subwords or tokens 102′ and enable a search capability that maps the words, subwords or tokens 102′ commonly used in a specific context with the context itself.

In embodiments, the vectorization module 110 includes a plurality of instructions of programmatic code which, when executed, implement the first ML model 112 that is trained to minimize the cosine distance between latent space representations of the target security assessment data (that is, the feature vectors or mathematical representations of the words, subwords or tokens 102′) and latent space representations of the context data (that is, the feature vectors or mathematical representations of the context data) and maximize the orthogonality of latent space representations of the target data and random unrelated contexts, topics or themes. In another embodiment, the vectorization module 110 includes a plurality of instructions of programmatic code which, when executed, implement the first ML model 112 that is trained to minimize a function of latent space representations of the target security assessment data (that is, the feature vectors or mathematical representations of the words, subwords or tokens 102′) with respect to latent space representations of the context data (that is, the feature vectors or mathematical representations of the context data) and maximize the orthogonality of latent space representations of the target data and random unrelated contexts, topics or themes.

In some embodiments, the first ML model 112 is a convolutional neural network or a recurrent neural network. In alternate embodiments, the first ML model 112 may be sub-types of recurrent neural networks (RNN) such as, for example, GRU and LSTM, attention based neural networks may be used for larger datasets (attention based neural networks in particular tend to be composite-for example, transformers which are attention layers combined with a dense layer). Also, in some embodiments, the contrastive learning algorithm is applied to neuron activations of one or more hidden layers of the first ML model 112.

The first ML model 112 aims to identify contexts, topics or themes based on word usage and assign an eigenvector to each context, topic or theme. The first ML model 112 uses the ReLU (rectified linear unit) function with He initializers to maximize the likelihood of generating sparse (composed of a majority of empty values) vector or latent space representations. The ReLU function turns negative numbers to zero and is highly effective when a known output is supposed to have many zeros. He initialization is designed to stop the vanishing and exploding gradient problem but works particularly well with ReLU function.

Within the operation of a neural network, generally speaking, there is a sequence of an input multiplied by a weight vector which is then passed through an activation function which, in turn, generates an output for the next layer in the neural network. ReLU, in embodiments, is used as an activation function and is defined as max (0, x). The ReLU function encourages the neural network to generate sparse outputs quickly (where a majority of entries in the vector are 0). This is particularly advantageous for generating eigenvectors and to obtain actionable outputs quickly. The weight vector also has to be initialized to a random value otherwise the neural network would always generate the same output. Pure random initialization, however, leads to training problems called vanishing and exploding gradients—both of which would generate an unusable model. Kaiming initialization or He initialization (which takes into account the non-linearity of activation functions such as ReLU), in particular, uses the variable bound defined as sqrt(2)/(sqrt(input_size*feature_size)), and then return random vectors initialized to (-bound, bound). The input size is the number of features and the feature size is the number of values in a feature vector. For example if we have tokens [a, b, c], the labels associated with the encoding for these tokens would be [1,2,3] and the one hot encoding would be [[1,0,0], [0,1,0], [0,0,1]], both examples have input size of 3 but the former example has feature size of 1 and the latter example has a feature size of 3.

Consequently, the first ML model 112 is configured to process the token IDs corresponding to every word, subword or token 102′ (corresponding to the target security assessment data) into a latent space embedding or feature vector and identify the most likely correlation of each word, subword or token 102′ with context data using an indexed vector search. It should be appreciated that the indexed vector search is performed within a repository of feature vectors of context data (the repository is populated using a trained ML model that generates the feature vectors of context data for the search). In various embodiments, data structures and algorithms created specifically for identifying near neighbors may be used for the indexed vector search. An example is the Ball Tree data structure that accelerates nearest neighbor searches and works with the cosine distance. In cases where the BallTree data structure cannot scale horizontally other accelerated vector search algorithms could be used such as HNSW or space filling curves. In some cases, a library that allows use of a high level API to implement nearest neighbor searches using a number of diverse data structures and algorithms which can scale might be used.

Thus, the first ML model 112 receives, as input, the token IDs corresponding to the words, subwords or tokens 102′ (that is, the target security assessment data) and outputs feature vectors 113 corresponding to the words, subwords or tokens 102′ (or latent space representations of the target security assessment data) associated or correlated with feature vectors 114 corresponding to the most relevant context data (or latent space representations of the most relevant context data).

It should be appreciated that using the contrastive learning algorithm, the feature vectors 113 corresponding to the words, subwords or tokens 102′ (or latent space representations of the target security assessment data), generated by the first ML model 112, are close to each other in the latent space if the words, subwords or tokens 102′ have similar configurations or semantic similarities. The contrastive learning algorithm works by labeling words that appear close to each other as correlated and random words as uncorrelated. Therefore, the generated feature vectors 113 corresponding to the words, subwords or tokens 102′ (or latent space representations of the target security assessment data) are such that correlated words are close to each other while unrelated words are not.

For training, the first ML model 112 is provided, as input, token ID sequences of a first training data-object of the training security assessment data and an associated or matching second training data-object of the training context data. Stated differently, the input is provided using associated or matching first and second data-objects. The first ML model 112 processes the token ID sequences of the first and second training data-objects into corresponding first and second training feature vectors. The first and second training feature vectors are an n-dimensional vector of token ID sequences representative of the first and second training data-objects. The association between the first and second training data-objects is a known relationship that is dependent on the input-for example, for user analysis it is the team, for host analysis it is the service that the hosts are a part of, for programmatic code it is the type of OWASP (Open Web Application Security Project) vulnerability that was present in the line of code and for vulnerabilities it is the tags associated with the indicators of compromise where they were used (note that these are not categories but rather unstructured text that is associated with the first data object). As an example for vulnerable code, an injection vulnerability could create a number of issues depending on the context since the same line of code could be responsible for remote code execution or server side request forgery for instance. With the use of word level associations with search, the systems and methods of the present specification can indicate that a code function is vulnerable to injection and is similar to functions where remote code execution was seen as well as server side request forgery all based on the similarity to the words used to describe the vulnerability. It should be appreciated that such association between the first and second training data-objects already exist and are established manually.

Subsequently, the first ML model 112 is configured to determine a loss between the first and second training feature vectors. In some embodiments, the loss is determined based on cosine similarity or Euclidean distance between the first and second training feature vectors and applying a contrastive loss function to the determined loss, wherein the contrastive loss function is directed towards reprimanding events where locations of the first and second training feature vectors are far apart in the corresponding shared feature space.

The contrastive loss function works by labeling words and contexts that are semantically similar to each other as correlated and uncorrelated to random contexts, themes or topics. It should be appreciated that based on the contrastive loss function, the first and second training feature vectors within the shared feature space are close to each other if the input first and second training data-objects have semantic similarity.

### Semantic Outlier(S) Detection Module 115

In embodiments, the semantic outlier(s) detection (SOD) module 115 includes a plurality of instructions of programmatic code which when executed implement a local outlier factor (LOF) algorithm.

In accordance with aspects of the present specification, to determine anomalies or outliers, the latent space representations of the target security assessment data—that is, the feature vectors 113 corresponding to the token IDs of the words, subwords or tokens 102′—are provided an input to the SOD module 115. Subsequently, the SOD module 115 outputs a feature vector 119 corresponding to those one or more words, subwords or tokens that are likely to be semantic anomalies or outliers within the words, subwords or tokens 102′. Since the vectorization module 110 already correlates the latent space representations of the words, subwords or tokens 102′ with the latent space representations of relevant context data, the feature vector 119 obtained as outlier is also associated or correlated with the feature vector of corresponding context data.

It should be appreciated that when the search index is created it stores the feature vector as well as the original value and maps them using a unique ID. An indexed vector search returns the ID of the closest feature vector which can then be used to retrieve the vector itself for explanations or the original text.

As known to persons of ordinary skill in the art, LOF is a density-based data of interest detection algorithm. It computes the local density of a given sample and compares it with the local density of its k nearest neighbors. The samples with much lower density than their neighbors are considered outliers. The number of neighbors (k) considered is user-defined and hence customizable.

The LOF algorithm involves the following steps:
a) Determine k-distance—that is, calculate distance between a feature vector and each of the plurality of feature vectors within the latent space representations of the target security assessment data (i.e., the words, subwords or tokens 102′). The distance may be calculated using a distance function such as, but not limited to, cosine distance or Euclidean distance;
b) Determine k-distance neighborhood—that is, calculate the kth nearest neighbor distance;
c) Determine the k nearest neighbors;
d) Using the k nearest neighbors, the local density for a feature vector is estimated by computing the local reachability density (LRD) which is defined as the inverse of average reachability density of the feature vector from its neighbors; and
e) Compute the LOF score for the feature vector by comparing the LRD of a feature vector with the LRDs of its k-neighbors. In other words, the LOF score (that is, the data of interest score) of each vector, is defined as the ratio of the average local density of its k-nearest neighbors, and its own local density.

Once the LOF scores for the plurality of feature vectors is calculated, the feature vectors are sorted based on the LOF scores in order to determine the outliers. The LOF score of a feature vector reveals its density compared to the densities of its neighbors. When the density of a feature vector is significantly smaller than the densities of the neighbors, it is determined that the feature vector is far from dense areas and hence a semantic data of interest or outlier.

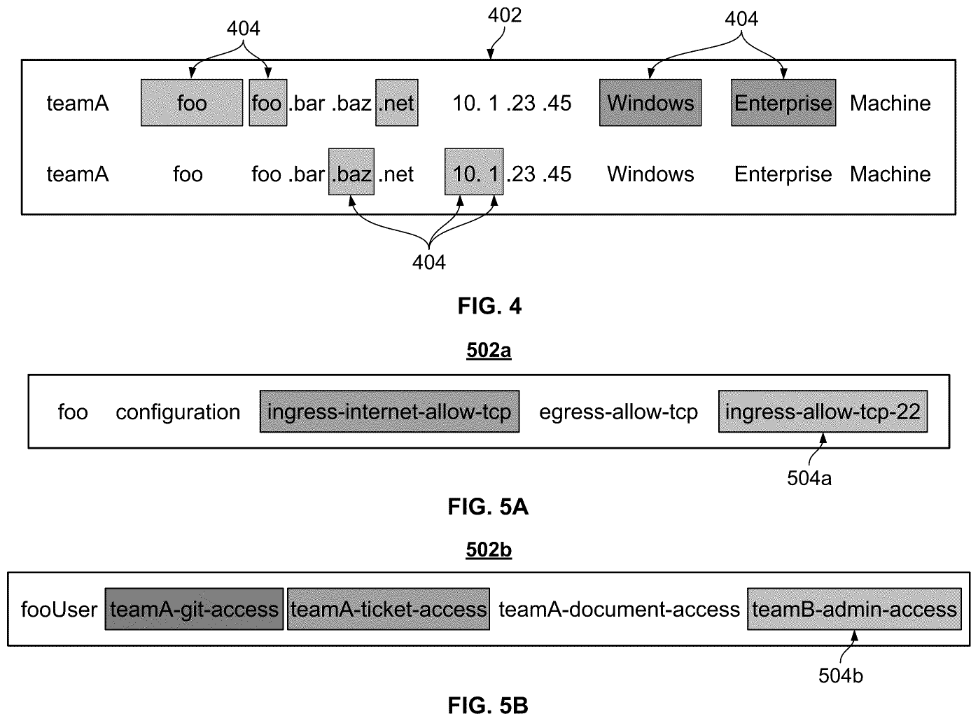

Thus, the SOD module 115 is enabled to flag outliers from the words, subwords or tokens 102′ while at the same time the first ML model 112 enables providing context data (using indexed vector search) most likely correlated with the flagged outliers. In a non-limiting example, if a cluster of a plurality of host severs is supposed to run a MySQL database and each of the plurality of host servers have the same 10 CVEs (Common Vulnerabilities and Exposures) associated with them, but a single host server has two additional CVEs that the others do not, then the SOD module 115 will identify the plurality of host servers in the cluster as similar and the single host server with additional CVEs as an outlier. One example CVE could be a loosely secured cloud storage system that allows attackers to access sensitive data. Another example CVE could be an open network port on a server which is further exploited through the installation of command and control malware. FIG. 5A shows an exemplary output 502a of the system, identifying a data of interest 504a indicating it is highly unusual for port 22 to be open on a cloud host. FIG. 5B shows another exemplary output 502b of the system, identifying anomalies 504b indicating it is unusual for users in team A to also have access for team B.

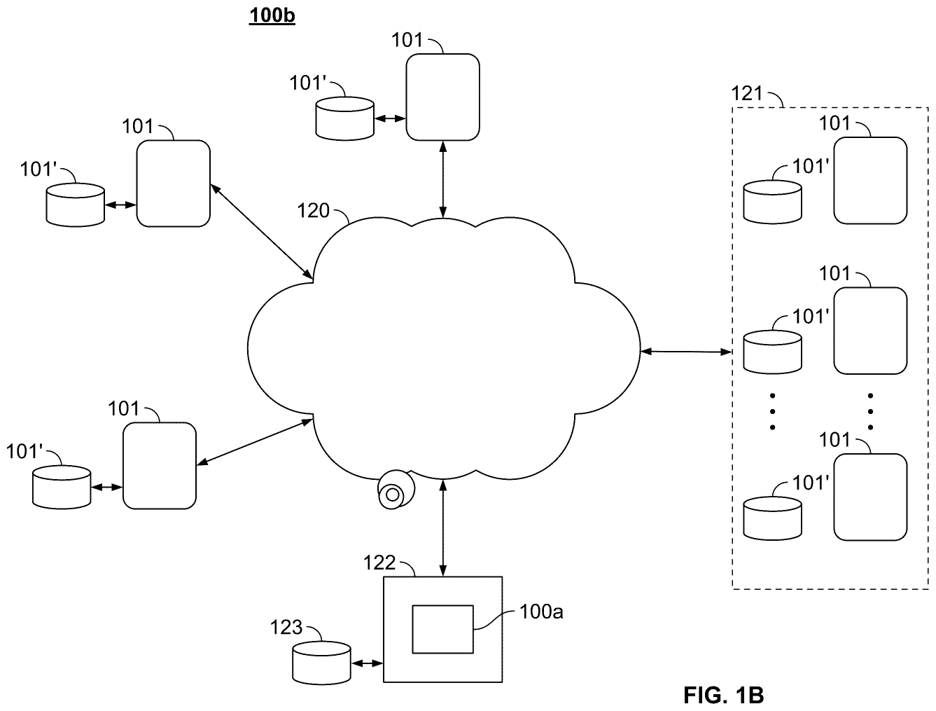

FIG. 2 depicts a point density graph 200 where a first plurality of data elements 202 associated with one or more hosts (in a cluster, for example) are represented by orange dots indicating that these are benign. Also shown are a second plurality of data points 204 represented by blue dots indicating that these hosts have been found, by the SOD module 115, to be anomalous or outliers.

The present specification provides context or information related to the data of interest for diagnosing the identified semantic data points of interest or outliers. In embodiments, as with the MySQL example above, the systems and methods described in the present specification are configured to determine if the identified additional CVEs have a high or a low CVSS (Common Vulnerability Scoring System) score and if threat actors have recently used the CVEs.

### Interpretation Module 125

Interpreting the results of the first ML model 112 and the SOD module 115 without guidance requires multiple hours of manual comparison to identify the common and uncommon configurations, leading to a degraded user experience. To improve customer experience, the present specification provides two interpretability pipelines for the models that highlight the specific parts of the input most important to the generated output. In some embodiments, the DOI output of the SOD module 115 is explained using an overfit comparison model and the similarity output of the first ML model 112 is explained using a sparse integrated gradient explanation.

Overfit comparison model—To explain why a specific data point (out of the words, subwords or tokens 102′) is inconsistent compared to its neighbors, the interpretation module 125 includes a plurality of instructions of programmatic code which when executed implement the modified classifier model 127 that is trained to explain the main commonalities and differences between data of interest and the rest of the neighborhood. In embodiments, the model 127 is any text classification model that relies on deep learning such as, for example, a CNN based classification model. The goal of a text classification model is to generalize, that means the model should be able to correctly categorize the data that is has seen as well as data that it has not seen before. However, the modified classifier model 127, by comparison, only needs to find the minimum difference between entries in the neighborhood and the specific item that was flagged. Therefore, all the normal safeguards against overfitting are removed (things like regularization, batch normalization, dropout etc.) thereby modifying a text classification model and generating the modified classifier model 127.

Stated differently, the modified classifier model 127 is intentionally overfit by repeating the data point of interest as a 1 and the benign data points near the data point of interest as −1 while removing the typical safeguards against overfitting, i.e., dropout or regularization. In some embodiments, an integrated gradients algorithm is applied to neuron activations of one or more hidden layers of the classifier model 127. While traditionally overfit models are a sign of a poorly designed model or data pipeline, it was found that running the integrated gradients algorithm on the classifier model 127 consistently identified the unique character sequences that make the target risk assessment data an outlier.

The integrated gradients algorithm aims to attribute an importance value to each input feature of a machine learning model based on the gradients of the model output with respect to the input. Specifically, the integrated gradients method defines an attribution value for each feature by considering the integral of the gradients taken along a straight path from a baseline instance x′ to the input instance x.

The process is sped up by batching multiple anomalies and benign data points in a single dataset and then training the classifier model 127 to identify the difference between them by generating a label vector where each individual output feature represents the data of interest category for the explanation. The value of the individual output feature is either 1 or −1, indicating whether the input is data of interest. A typical classifier would output 0 if something is classified as benign and 1 if something is classified as not benign. If there are 10 entries, however, that would require training of 10 models. Therefore, to speed up processing there is an output vector instead of a single value (0 and 1) where the location in the vector represents the item being analyzed and the value of the vector defines whether the input is benign or not. The values of 1 and −1 were used because 0 is a default value in the vector so that would mean all entries being explained would be represented by the same value in the output and would make the explanation highly inaccurate.

Sparse integrated gradient explanation—is based on an observation that the output from the first ML model 112 are sparse vectors typically containing ˜5 non-zero values. This allows explaining a data point by capturing the input's influence on non-zero features. While full embedding is computationally expensive to run the integrated gradients, the interpretation module 125 only needs to capture and aggregate data for an average of five features out of 256 using this methodology.

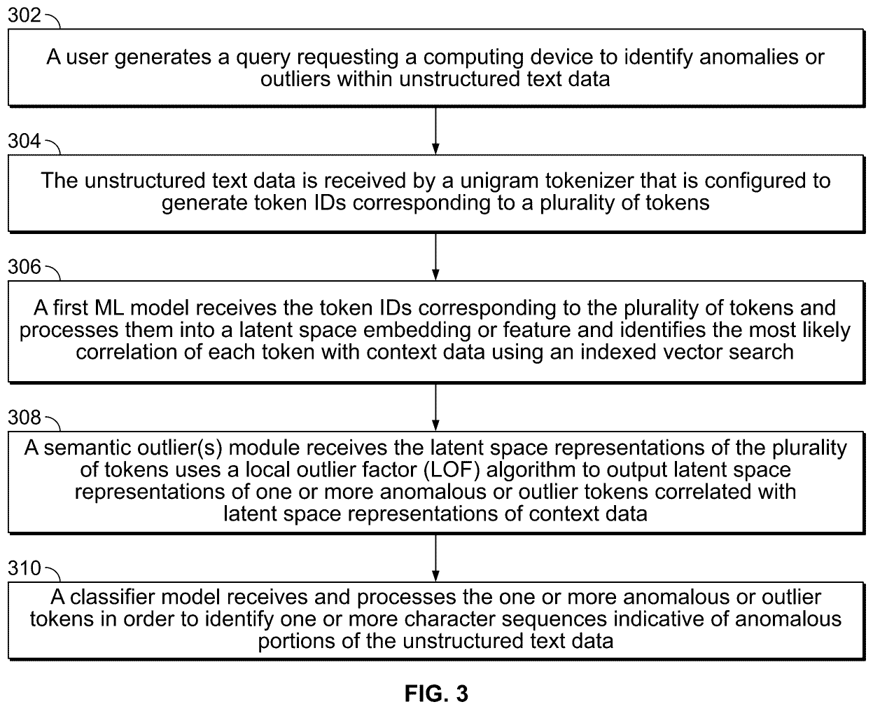

FIG. 4 shows example data 402 for interpreting outputs of the DOI detection and diagnosis system 100a, in accordance with some embodiments of the present specification. The example data 402 represents the output of the first ML model 112 applied on a host and shows two explanations, the first explanation is indicative of why an entry is materially different from other similar hosts in the neighborhood and the second explanation is indicative of the values that define the neighborhood. The outcome from the first ML model 112 indicates that in a subnet, hosts share the baz-hostname prefix, and they are not typically associated with either the foo subdomain or .net TLD (top-level domain) and, to some extent, the Windows OS. This is because, in the 10.1.23.45 subnet, there is some overlap that can be seen between endpoints, with a different operating system being predominant. Thus, a conclusion would be that within the subnet 10.1.23.* it is uncommon to find Windows enterprise machines with a .foo domain. The shaded portions 404 are indicative of an outcome of the interpretation module 125 and correspond to specific tokens (subwords here) that were most important when the first ML model 112 made a decision. In some embodiments, the intensity of the color of the shaded portions 404 is indicative of how important the subword was.

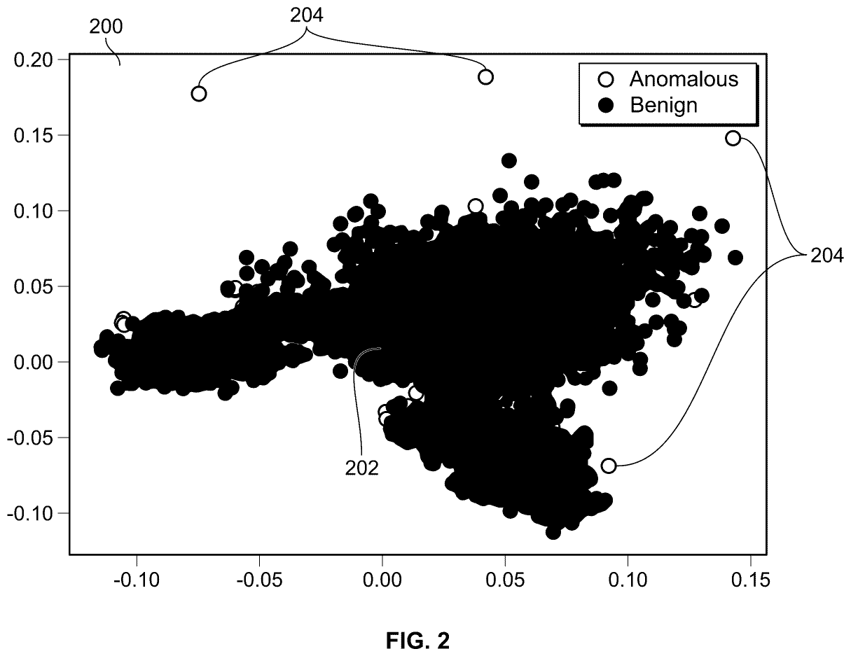

FIG. 3 is a flowchart of a plurality of steps of a method of detecting and diagnosing anomalies or outliers in unstructured text data and correlating the unstructured text data with most likely context data, in accordance with some embodiments of the present specification. In embodiments, the unstructured text data is generated in the context of identifying misconfigurations and related events within an IT infrastructure or asset inventory.

At step 302, a user generates a query requesting a computing device to identify anomalies or outliers within the unstructured text data. In some embodiments, the unstructured text data is accessed from a database.

At step 304, the unstructured text data is received by a unigram tokenizer that is configured to generate token ID sequences corresponding to a plurality of tokens that are generated by determining all possible segmentations of the unstructured text data, calculating the probability of each segmentation and selecting the segmentation with the highest probability. Thus, the unstructured text data is divided into meaningful tokens or subword units according to their likelihood of occurrence.

At step 306, a first ML model receives the token ID sequences corresponding to the plurality of tokens and is configured to process every token ID (corresponding to the plurality of tokens of the unstructured text data) into a latent space embedding or feature vector (also referred to as latent space representations of the plurality of tokens) and identify the most likely correlation of each token with context data using an indexed vector search.

To do so, the first ML model is trained to minimize the cosine distance between latent space representations of the unstructured text data (that is, the feature vectors or mathematical representations of the tokens) and latent space representations of the context data (that is, the feature vectors or mathematical representations of the context data) and maximize the orthogonality of latent space representations of the unstructured text data and random unrelated contexts, topics or themes.

In some embodiments, the first ML model is a convolutional neural network or a recurrent neural network. Also, in some embodiments, a contrastive learning algorithm is applied to neuron activations of one or more hidden layers of the first ML model.

At step 308, a semantic outlier(s) module receives the latent space representations of the plurality of tokens and is configured to use a local outlier factor (LOF) algorithm to output latent space representations of one or more anomalous or outlier tokens correlated with latent space representations of context data.

At step 310, a classifier model receives and processes the one or more anomalous or outlier tokens in order to identify one or more character sequences indicative of inconsistent portions of the unstructured text data. In some embodiments, an integrated gradients algorithm is applied to neuron activations of one or more hidden layers of the classifier model. The classifier model is trained to explain the main commonalities and differences between each of the one or more anomalous or outlier data points and the rest of the neighborhood. In some embodiments, the classifier model is a text classification model such as, for example, a CNN that has been intentionally overfit by repeating the data of interest as a 1 and the benign data points near the data of interest as −1 while removing the typical safeguards against overfitting.

### Exemplary Use Case Scenarios

A potential first use case for the systems and methods of the present specification would be to identify hosts that are configured differently from the rest of the network. Two example outputs from the first ML model 112 and the interpretation model 125 can be seen in FIG. 4 and FIG. 5A. While FIG. 4 shows an output where a host is using a non-standard operating system and naming, FIG. 5A shows an example where hosts that have internet access as well as port 22 open to the Internet are misconfigured.

A second potential use case for the systems and methods of the present specification is to identify access that is excessive in the context of the standard practices for a team or organization that a user is part of. An example output from the first ML model 112 and the interpretation model 125 can be seen in FIG. 5B where excessive access is identified based on the generic access for team A.

The above examples are merely illustrative of the many applications of the systems and methods of the present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

What is claimed is:

1. A computer implemented method of identifying one or more anomalies within a first set of data, comprising:
using a computing device, generating a graphical user interface configured to receive a request to identify one or more anomalies in the first set of data;
receiving the first set of data in response to the user's query;
generating a plurality of tokens representative of the first set of data;
using a tokenizer, generating token ID sequences corresponding to the plurality of tokens;
using a first machine learning model, processing the token ID sequences into first latent space representations;
using the first machine learning model, associating each of the plurality of tokens with one or more portions of context data by correlating the first latent space representations with the one or more portions of context data; and
processing the first latent space representations to identify the one or more anomalies, wherein the one or more anomalies is correlated with the one or more portions of context data.

2. The computer implemented method of claim 1, wherein the first set of data comprises data related to security assessments of a plurality of networked hosts.

3. The computer implemented method of claim 2, wherein the one or more portions of context data comprises data indicative of environments, events, topics or themes associated with at least a subset of the data related to said security assessments.

4. The computer implemented method of claim 2, wherein the one or more portions of context data comprises at least one of host names, host configurations, identity and access management policies, user names, user permissions, and insecure code lines.

5. The computer-implemented method of claim 1, wherein the first set of data is unstructured text data.

6. The computer-implemented method of claim 1, further comprising generating the plurality of tokens by determining a plurality of possible segmentations of the first set of data, calculating a probability of each of the segmentations and selecting one or more segmentations with highest probabilities.

7. The computer-implemented method of claim 1, further comprising generating the correlation by training the first machine learning model to minimize cosine distance between the first latent space representations and one or more second latent space representations of context data.

8. The computer-implemented method of claim 7, further comprising generating the correlation by maximizing orthogonality of the first latent space representations and unrelated context data.

9. The computer-implemented method of claim 1, wherein the first machine learning model is a at least one of a recurrent neural network or convolutional neural network and further comprising applying a contrastive learning algorithm to neuron activations of one or more hidden layers of the first machine learning model.

10. The computer-implemented method of claim 1, further comprising, using the tokenizer, applying a unigram language model.

11. The computer-implemented method of claim 1, further comprising identifying one or more character sequences indicative of inconsistent portions of the first set of data using a classifier model and applying an integrated gradients algorithm to neuron activations of one or more hidden layers of the classifier model.

12. A computer implemented method of identifying one or more outliers in unstructured data related to security assessments of a plurality of networked hosts, comprising:
receiving a request to identify one or more outliers in the unstructured data;
receiving the unstructured data in response to the request;
generating a plurality of tokens representative of the unstructured data and token ID sequences corresponding to the plurality of tokens using a tokenizer;
processing the token ID sequences into first latent space representations using a first machine learning model;
using the first machine learning model, correlating the first latent space representations with context data in order to associate each of the plurality of tokens with most likely context data, wherein the context data comprises at least one of host names, host configurations, identity and access management policies, user names, user permissions, and insecure code lines;
processing the first latent space representations to identify the one or more outliers, wherein each of the one or more outliers is correlated with context data; and
processing, by a classifier model, the identified one or more outliers in order to identify one or more character sequences indicative of inconsistent portions of the unstructured data.

13. The computer-implemented method of claim 12, wherein the unstructured data is text data.

14. The computer-implemented method of claim 12, further comprising generating the plurality of tokens by determining a plurality of possible segmentations of the unstructured data, calculating a probability of each of the segmentations and selecting one or more segmentations with highest probabilities.

15. The computer-implemented method of claim 12, further comprising generating the correlation by training the first machine learning model to minimize cosine distance between the first latent space representations and one or more second latent space representations of context data.

16. The computer-implemented method of claim 15, further comprising maximizing orthogonality of the first latent space representations and unrelated context data.

17. The computer-implemented method of claim 12, wherein the first machine learning model is at least one of a recurrent neural network or convolutional neural network and further comprising applying a contrastive learning algorithm to neuron activations of one or more hidden layers of the first machine learning model.

18. The computer-implemented method of claim 12, further comprising, using the tokenizer, applying a unigram language model.

19. The computer-implemented method of claim 12, further comprising identifying one or more character sequences indicative of inconsistent portions of the unstructured data using a classifier model.

20. The computer-implemented method of claim 19, further comprising applying an integrated gradients algorithm to neuron activations of one or more hidden layers of the classifier model.
